(19) United States
(12) Patent Application Publication
(10) Pub. No.: US 2014/0068601 A1
(43) Pub. Date: Mar. 6, 2014

(54) SYSTEM AND METHOD FOR LIVE COMPUTER FORENSICS

(71) Applicants: Michael J. Simms, Indialantic, FL (US); Ryan C. Salsamendi, Palm Bay, FL (US); John R. Wagner, Melbourne, FL (US)

(72) Inventors: Michael J. Simms, Indialantic, FL (US); Ryan C. Salsamendi, Palm Bay, FL (US); John R. Wagner, Melbourne, FL (US)

(73) Assignee: Raytheon Company, Waltham, MA (US)

(21) Appl. No.: 13/599,800

(22) Filed: Aug. 30, 2012

(51) Int. Cl. G06F 9/455

(52) U.S. Cl. 718/1

(57) ABSTRACT

Embodiments of a system and method for live computer forensics are generally described herein. The system can include a first hypervisor configured to halt a computer system, the computer system including a central processing unit, a drive, a volatile memory, and a non-volatile memory. The first hypervisor can be configured to collect data representative of the state of the computer system at the time the computer system was halted. The data representative of the state of the computer system can include the contents of the volatile and non-volatile memory at the time the computer system was halted, wherein at least a portion of the collected data is representative of the state of the central processing unit and the contents of the drive, at the time the computer system was halted.

### TECHNICAL FIELD

This disclosure relates generally to hypervisors and using hypervisors for live computer forensics.

### BACKGROUND ART

Current static memory forensics techniques may not be sufficient to gain a snapshot of a computer system when the computer system includes encrypted information or may not be able to capture volatile information after the computer system is powered down.

### BRIEF DESCRIPTION OF THE DRAWINGS

FIG. 1 is a block diagram of an example of a computer system, in accord with one or more embodiments.

FIG. 2 is a block diagram of an example of an analysis system, in accord with one or more embodiments.

FIG. 3 is a flow diagram of an example of a technique of capturing the state of a computer system, in accord with one or more embodiments.

FIG. 4 is a flow diagram of an example of a technique of analyzing the state of a computer system, in accord with one or more embodiments.

FIG. 5 is a block diagram of an example of a computer system to implement methods, in accord with one or more embodiments.

### DESCRIPTION OF THE EMBODIMENTS

In the following detailed description, reference is made to the accompanying drawings that form a part hereof, and in which is shown by way of illustration specific embodiments in which the inventive subject matter can be practiced. These embodiments are described in sufficient detail to enable those skilled in the art to practice them, and it is to be understood that other embodiments can be utilized and that structural, logical, and electrical changes can be made without departing from the scope of the inventive subject matter. Such embodiments of the inventive subject matter can be referred to, individually and/or collectively, herein by the term “invention” merely for convenience and without intending to limit the scope of this application to any single invention or inventive concept if more than one is in fact disclosed. The following description is, therefore, not to be taken in a limited sense, and the scope of the inventive subject matter is defined by the appended claims.

Embodiments of a system and method for live computer forensics are generally described herein. The system can include a first hypervisor configured to halt a computer system, the computer system can include a central processing unit, a drive, a volatile memory, and a non-volatile memory. The first hypervisor can be configured to collect data representative of the state of the computer system at the time the computer system was halted. The data representative of the state of the computer system can include the contents of the volatile and non-volatile memory at the time the computer system was halted, wherein at least a portion of the collected data is representative of the state of the central processing unit and the contents of the drive, at the time the computer system was halted.

Computer problems (e.g., bugs) can be difficult to isolate and solve. Solving computer problems can be difficult with malware or a virus such as a rootkit that subverts or changes the kernel of a computer. Another difficulty associated with solving computer problems can be achieving a snapshot of a computer system that is consistent (e.g., coherent) with respect to time.

A possible way to help solve computer problems such as these can include taking a snapshot of an entire computer system (e.g., central processing unit (CPU), memory, or one or more drives) and loading the snapshot onto an analysis system.

A hypervisor includes a hardware virtualization technique that allows multiple operating systems (guests) to run concurrently on a computer. Hypervisors, such as type I hypervisors, can be installed on server hardware to run guest operating systems. Hypervisors, such as type II hypervisors, can run an operating system within an operating system environment.

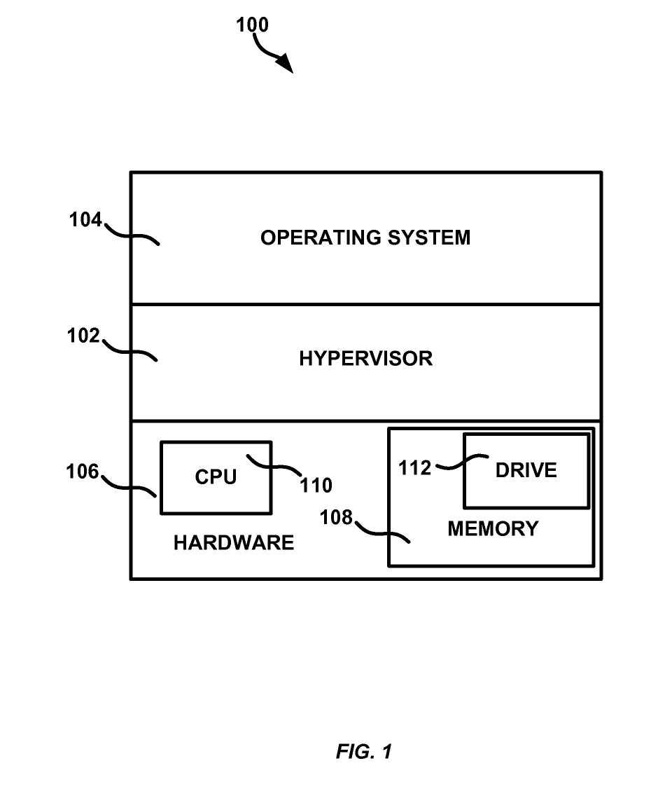

FIG. 1 shows an example of a computer system 100. The computer system 100 can include a hypervisor 102, an operating system 104, or hardware 106.

The hypervisor 102 is operable to control the hardware 106 or manage the operating system 104. The hypervisor can be a Type-I (e.g., bare-metal) hypervisor that runs on the hardware 106. Example Type-I hypervisors include Oracle® VM Server for SPARC®, Citrix® XenServer®, KVM (Kernel-based Virtual Machine), VMware® ESX®/ESXi, or Microsoft® Hyper-V. The hypervisor 102 can be provided with a higher privilege level than the operating system 104, such as by situating the hypervisor 102 between the operating system 104 and the hardware 106. In this configuration, the operating system 104 supervises drivers and applications, among others, and the hypervisor 102 hypervises the operating system 104.

The hypervisor 102 can be configured to hot-load itself (e.g., install itself at run-time) between a running instance of the operating system 104 and the hardware 106. In such embodiments, a driver can manage the loading and initialization of the hypervisor 102. An application launcher associated with the computer system 100 can install a driver such that, from the perspective of a user, running the application launcher accomplishes hot-loading.

The hypervisor 102 can be configured to boot load, such as to be a part of the permanent configuration of the computer system 100. Such embodiments can include corporate enterprise applications or other applications that can include a live memory forensics tool.

The hypervisor 102 can be configured to use virtual machine extensions to make the operating system 104 a guest system of the hypervisor 102. The hypervisor 102 can be configured to halt the computer system 100, such as a running instance of the operating system 104 or the hardware 106. The hypervisor 102 can be configured to export (e.g., transmit), using the hardware 106, the contents of a memory 108, at the time the computer system 100 was halted, such as to an external memory. In such embodiments, a port driver such as a USB (Universal Serial Bus), an Ethernet, an advanced technology attachment (ATA), a serial advanced technology attachment (SATA), a FireWire®, or other data transfer protocol driver can be used to export the data representative of the state of the computer system 100.

The hypervisor 102 can be configured to command the operating system 104 (e.g., a guest operating system) to transmit the data representative of the state of the computer system 100, such as to an external memory device. In such embodiments, the operating system 104 can change a state to perform a write operation to the external memory. To get a snapshot of the computer system 100 that is coherent with respect to time, the pages of memory 108 can be marked as “copy-on-write”. By marking the pages copy-on-write a kernel of the operating system 104 can intercept the operation that will modify a page of the memory 108 and copy that page of memory 108 before or after the modification. In this way all of the memory can be copied so as to be coherent with respect to time.

The data representative of the state of the computer system 100 can be compressed before it is sent to an external memory. Example compression algorithms include Lempel-Ziv compression and variations thereof, Burrows-Wheeler transform compression and variations thereof, Sequitur, Re-Pair, Huffman compression and variations thereof, among others.

The operating system 104 is operable to manage the hardware 106 or provide support for application execution. Example operating systems include Android®, BSD (Berkeley Software Distribution), iOS®, OS X®, Microsoft® Windows®, Windows Phone®, IBM® (International Business Machines Corporation) z/OS®, or UNIX®, among others. The operating system 104 can include a set of CPU 110 (e.g., processor) instructions that provide support for virtual machines. A virtual machine control structure can be provided to the CPU 110 of the computer system 100. The virtual machine control structure can govern how the CPU 110 transitions between host and guest environments (e.g., virtual machine entry and virtual machine exit). A software program configured to replicate the function of machine code commands, such as machine code commands that provide support for virtual machines, of another processing environment can be used to implement the set of processor instructions that provides support for virtual machines. The software program can be an x86 emulator configured to replicate the function of x86 machine code.

The hardware 106 is the collection of physical elements that comprise the computer system 100. The hardware 106 can include one or more processors, such as a central processing unit (CPU) 110, a graphics board, a power board, a disk, the memory 108, one or more drives 112 (e.g., one or more disk drives), a display screen, a keyboard, a printer, or a chip, among other hardware.

The memory 108 can be operable to store data for the computer system 100. The memory 108 can include volatile memory, non-volatile memory, or a combination thereof. The memory 108 can include random access memory (RAM), read only memory (ROM), or a combination thereof. The memory 108 can include primary memory, secondary memory, or a combination thereof. The memory 108 can include the one or more drives 112.

The CPU 110 is the hardware 106 within the computer system 100 that executes instructions of a computer program by performing arithmetical, logical, and I/O (input/output) operations. The CPU 110 can extract the instructions from the memory 108.

The one or more drives 112 can be operable to store data to be accessed by the operating system 104 or the CPU 110. Some drives, such as optical drives, can be operable to read data from a compact disk (CD) or a digital video disk (DVD). In a typical computer system 100, the “C” drive is where operating system 104 data and downloaded data is stored, the “D” drive is a recovery partition, and the “E” drive is an optical drive.

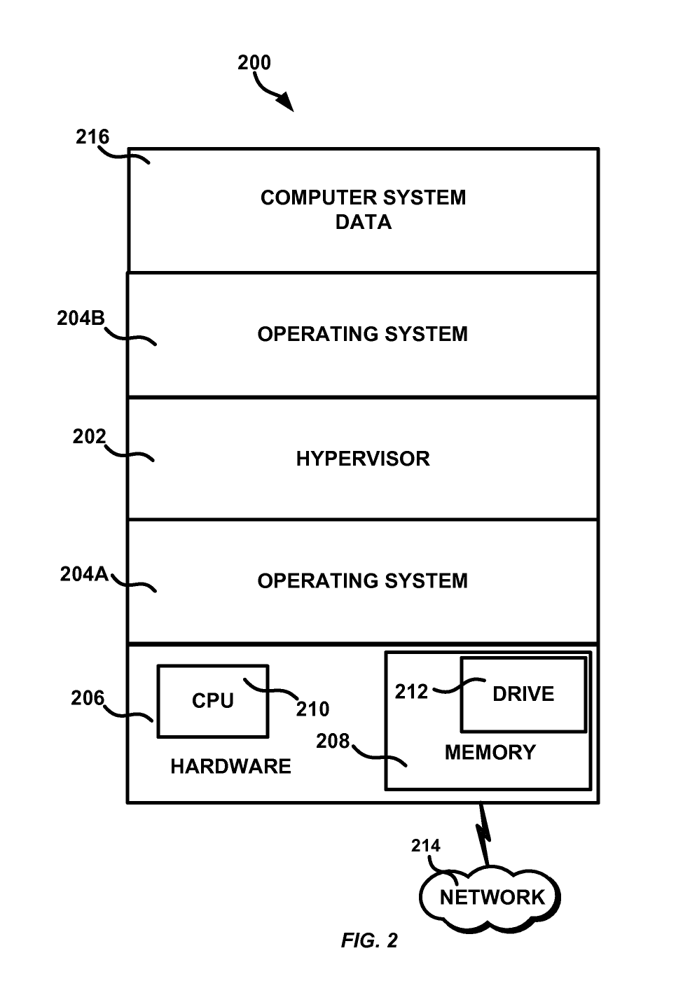

FIG. 2 shows an example of an analysis system 200. The analysis system 200 can include a hypervisor 202, first and second operating systems 204A and 204B, or hardware 206.

The hypervisor 202 can be configured to run within the first operating system 204A and host the second operating system 204B. The hypervisor 202 can be a Type-II hypervisor that can be configured to create a virtual machine environment and coordinate calls for the CPU 210, the memory 208, network 214, and other resources, such as through the first operating system 204A.

The first and second operating systems 204A-B can be substantially similar to operating system 104. Operating system 204A can run on the hardware 206. Operating system 204B can be hosted by the hypervisor 202, such as by running operating system 204B as a virtual machine.

The operating system 204 can be configured to analyze computer system data 216. The computer system data 216 can include the contents of at least a portion of volatile and non-volatile memory, such as the memory 108 of computer system 100. The computer system data 216 can include the state of the CPU 110, or the contents of the one or more drives 112, such as at the time the computer system 100 was halted.

The hypervisor 202 can be configured to include an interactive debugger that provides the user with the ability to step through an instruction stream or a breakpoint manager that manages the breakpoints for the interactive debugger. Such configurations can be helpful in detecting malware.

The hypervisor 202 can be configured to include a memory viewer tool that provides a user with the contents of the memory 108, such as at a user-specified address. The hypervisor 202 can be configured to include a memory search tool that provides a user with the ability to scan the contents of the memory 108 for a specific string of data (e.g., bits), such as a user-specified bit-string. The hypervisor can be configured to include a decryption key search tool that can be configured to search the computer system data 216 for decryption keys contained therein. The hypervisor 202 can be configured to include a network display tool that can be configured to display network data packets or associated metadata, such as source and destination IP addresses of the network data packets, packet transfer protocol information, or Transmission Control Protocol (TCP) or User Datagram Protocol (UDP) port numbers.

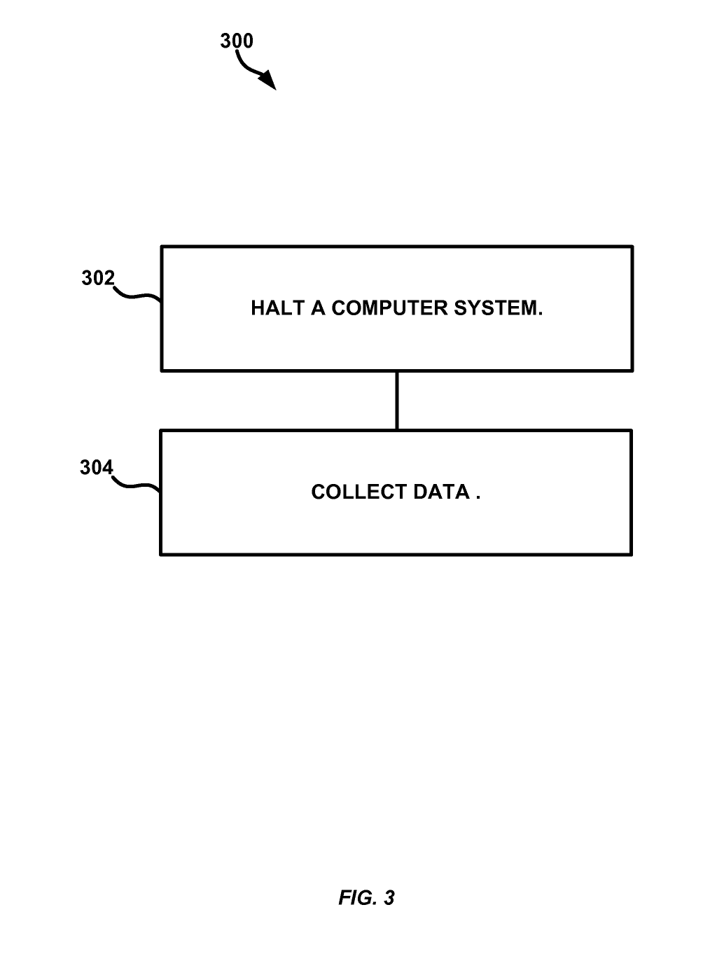

FIG. 3 shows an example of a technique 300 of capturing the state of the computer system 100. At 302, the computer system 100 can be halted. At 304, data representative of the state of the computer system 100 can be collected. The data collected can be coherent with respect to time (e.g., reflect the state of data at a single clock cycle of the computer system 100). The data collected can be representative of the state of the computer system 100 at the time the computer system 100 was halted and can include the contents of the memory 108. At least a portion of the data collected can be representative of the state of the CPU 110 or the contents of the drive 112.

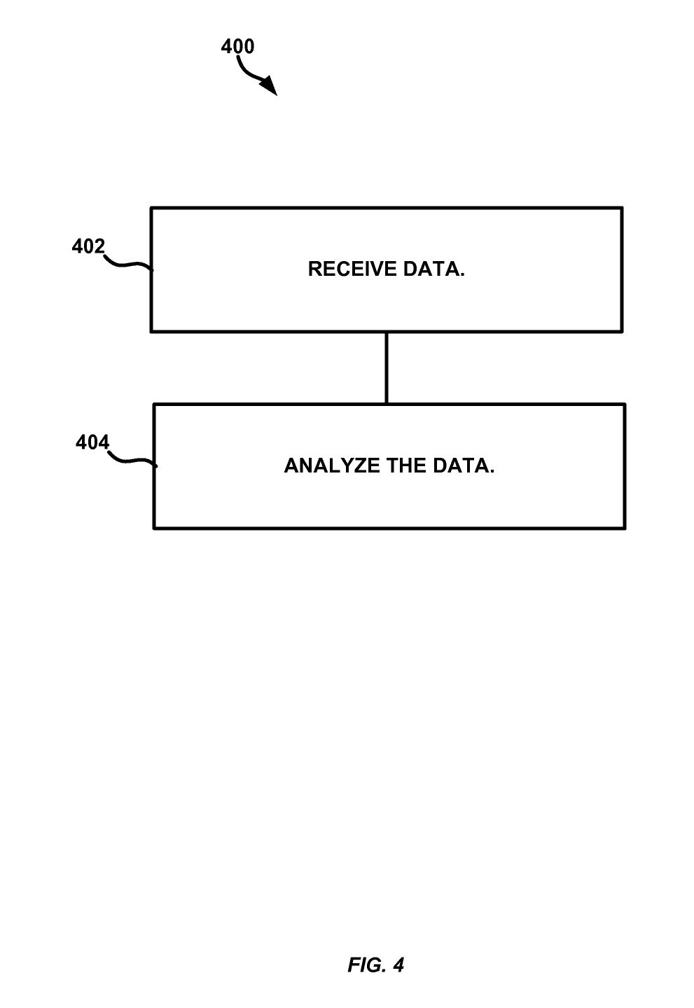

FIG. 4 shows an example of a technique 400 of analyzing the state of the computer system 100. At 402, data can be received at the analysis system 200. The data can be data representative of the state of the computer system 100 that has been collected, such as at 304. At 404, the data can be analyzed. The analysis can include stepping through the data received, such as instruction by instruction, to recreate what was happening in the computer system 100 at or around the time the computer system 100 was halted. The analysis can be accomplished using the analysis system 200.

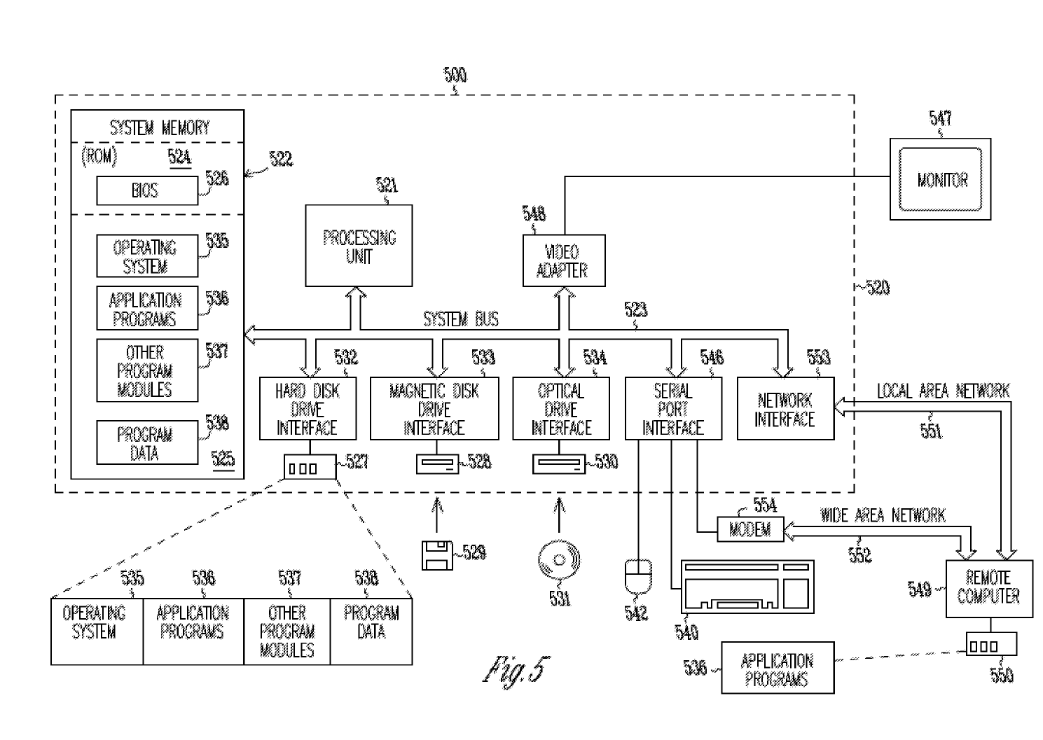

FIG. 5 is a block diagram of a computer system to implement methods, according to an example embodiment. In the embodiment shown in FIG. 5, a hardware and operating environment is provided that is applicable to any of the servers and/or remote clients shown in the other Figures.

As shown in FIG. 5, one embodiment of the hardware and operating environment includes a general purpose computing device in the form of a computer 500 (e.g., a personal computer, workstation, or server), including one or more processing units 521, a system memory 522, and a system bus 523 that operatively couples various system components including the system memory 522 to the processing unit 521. There can be only one or there can be more than one processing unit 521, such that the processor of computer 500 comprises a single CPU, or a plurality of processing units, commonly referred to as a multiprocessor or parallel-processor environment. In various embodiments, computer 500 is a conventional computer, a distributed computer, or any other type of computer.

The system bus 523 can be any of several types of bus structures including a memory bus or memory controller, a peripheral bus, and a local bus using any of a variety of bus architectures. The system memory can also be referred to as simply the memory, and, in some embodiments, includes read-only memory (ROM) 524 and random-access memory (RAM) 525. A basic input/output system (BIOS) program 526, containing the basic routines that help to transfer information between elements within the computer 500, such as during start-up, can be stored in ROM 524. The computer 500 further includes a hard disk drive 527 for reading from and writing to a hard disk, not shown, a magnetic disk drive 528 for reading from or writing to a removable magnetic disk 529, and an optical disk drive 530 for reading from or writing to a removable optical disk 531 such as a CD ROM or other optical media.

The hard disk drive 527, magnetic disk drive 528, and optical disk drive 530 couple with a hard disk drive interface 532, a magnetic disk drive interface 533, and an optical disk drive interface 534, respectively. The drives and their associated computer-readable media provide non volatile storage of computer-readable instructions, data structures, program modules and other data for the computer 500. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), redundant arrays of independent disks (e.g., RAID storage devices) and the like, can be used in the exemplary operating environment.

A plurality of program modules can be stored on the hard disk, magnetic disk 529, optical disk 531, ROM 524, or RAM 525, including an operating system 535, one or more application programs 536, other program modules 537, and program data 538. Programming for implementing one or more processes or method described herein can be resident on any one or number of these computer-readable media.

A user can enter commands and information into computer 500 through input devices such as a keyboard 540 and pointing device 542. Other input devices (not shown) can include a microphone, joystick, game pad, satellite dish, scanner, or the like. These other input devices are often connected to the processing unit 521 through a serial port interface 546 that is coupled to the system bus 523, but can be connected by other interfaces, such as a parallel port, game port, or a universal serial bus (USB). A monitor 547 or other type of display device can also be connected to the system bus 523 via an interface, such as a video adapter 548. The monitor 547 can display a graphical user interface for the user. In addition to the monitor 547, computers typically include other peripheral output devices (not shown), such as speakers and printers.

The computer 500 can operate in a networked environment using logical connections to one or more remote computers or servers, such as remote computer 549. These logical connections are achieved by a communication device coupled to or a part of the computer 500; the invention is not limited to a particular type of communications device. The remote computer 549 can be another computer, a server, a router, a network PC, a client, a peer device or other common network node, and typically includes many or all of the elements described above I/O relative to the computer 500, although only a memory storage device 550 has been illustrated. The logical connections depicted in FIG. 5 include a local area network (LAN) 551 and/or a wide area network (WAN) 552. Such networking environments are commonplace in office networks, enterprise-wide computer networks, intranets and the internet, which are all types of networks.

When used in a LAN-networking environment, the computer 500 is connected to the LAN 551 through a network interface or adapter 553, which is one type of communications device. In some embodiments, when used in a WAN-networking environment, the computer 500 typically includes a modem 554 (another type of communications device) or any other type of communications device, e.g., a wireless transceiver, for establishing communications over the wide-area network 552, such as the internet. The modem 554, which can be internal or external, is connected to the system bus 523 via the serial port interface 546. In a networked environment, program modules depicted relative to the computer 500 can be stored in the remote memory storage device 550 of remote computer 549. It is appreciated that the network connections shown are exemplary and other means of, and communications devices for, establishing a communications link between the computers can be used including hybrid fiber-coax connections, T1-T3 lines, DSL's, OC-3 and/or OC-12, TCP/IP, microwave, wireless application protocol, and any other electronic media through any suitable switches, routers, outlets and power lines, as the same are known and understood by one of ordinary skill in the art.

An advantage of one or more embodiments can include providing a snapshot of an entire computer system at a particular point in time with little disturbance to the state of the computer system. This snapshot can be useful for doing memory forensics or other analyses of the computer system at the time of the snapshot.

### ADDITIONAL NOTES AND EXAMPLES

In Example 1 a system comprises a first hypervisor 102 configured to halt a computer system 100, the computer system including a central processing unit 110, a drive 112, a volatile memory, or a non-volatile memory 108.

In Example 2, Example 1 includes the first hypervisor configured to collect data representative of the state of the computer system at the time the computer system was halted, the data representative of the state of the state of the computer system including the contents of the volatile and non-volatile memory at the time the computer system was halted, wherein at least a portion of the collected data is representative of the state of the central processing unit and the contents of the drive, at the time the computer system was halted.

In Example 3, the first hypervisor of at least one of Examples 1-2 is configured to hot-load itself between a running instance of an operating system 104 and hardware of the computer system.

In Example 4, the first hypervisor of at least one of Examples 1-3 is a type I hypervisor.

In Example 5, the first hypervisor of at least one of Examples 1-4 is configured to transmit the data representative of the state of the computer system to an external memory.

In Example 6, the first hypervisor of at least one of Examples 1-5 is configured to transmit, using a universal serial bus (USB), the data representative of the state of the computer system.

In Example 7, the data representative of the state of the computer system of at least one of Examples 1-6 includes data representative of the entire contents of all volatile and non-volatile memory of the computer system at the time the computer system was halted.

In Example 8, the data representative of the state of the computer system of at least one of Examples 1-7 includes data representative of the entire state of the operating system of the computer system at the time the computer system was halted.

In Example 9, the first hypervisor of at least one of Examples 1-8 is configured to compress the data representative of the state of the computer system before transmitting the data representative of the state of the computer system.

In Example 10, the system of at least one of Examples 1-9 includes an analysis tool.

In Example 11, the analysis tool of at least one of Examples 1-10 includes a second hypervisor 202.

In Example 12, the second hypervisor of at least one of Examples 1-11 is configured to receive the data representative of the state of the computer system at the time the computer system was halted.

In Example 13, the second hypervisor of at least one of Examples 1-12 is configured to help analyze the data representative of the state of the computer system.

In Example 14, the second hypervisor of at least one of Examples 1-13 is a type II hypervisor.

In Example 15, a method comprises halting, using a first hypervisor, a computer system.

In Example 16, the method of at least one of Examples 1-15 includes collecting, using the first hypervisor, data representative of the state of the computer system at the time the computer system was halted.

In Example 17, collecting the data representative of the state of the computer system at the time the computer system was halted of at least one of Examples 1-16 includes collecting the contents of a volatile memory of the computer system and a non-volatile memory of the computer system, at the time the computer system was halted.

In Example 18, collecting data of the state of the computer system at the time the computer system was halted of at least one of Examples 1-17 includes collecting data representative of the state of a central processing unit of the computer system and the contents of a drive of the computer system, at the time the computer system was halted.

In Example 19, the halting, using the first hypervisor, of at least one of Examples 1-18 includes halting the computer system using a type I hypervisor.

In Example 20, the method of at least one of Examples 1-19 includes hot-loading, using the first hypervisor, the first hypervisor between a running instance of the operating system and hardware of the computer system.

In Example 21, the method of at least one of Examples 1-20 includes transmitting the data representative of the state of the computer system to an external memory.

In Example 22, transmitting the data representative of the state of the computer system of at least one of Examples 1-21 includes transmitting, using a universal serial bus (USB), the data representative of the state of the computer system.

In Example 23, transmitting the data representative of the state of the computer system of at least one of Examples 1-22 includes transmitting data representative of the entire state of all volatile and non-volatile memory of the computer system at the time the computer system was halted.

In Example 24, transmitting the data representative of the state of the computer system of at least one of Examples 1-23 includes transmitting data representative of the entire state of the operating system of the computer system at the time the computer system was halted.

In Example 25, the method of at least one of Examples 1-24 includes compressing the data representative of the state of the computer system.

In Example 26, the method of at least one of Examples 1-25 includes receiving the data representative of the state of the computer system at a second hypervisor.

In Example 27, the method of at least one of Examples 1-26 includes analyzing the state of the computer system using, at least partially, the second hypervisor.

In Example 28, receiving the data representative of the state of the computer system of at least one of Examples 1-27 includes receiving the data representative of the state of the computer system at a type II hypervisor.

In Example 29 a machine readable storage device that stores instructions, the instructions, which when performed by a machine, cause the machine to perform operations comprising halting, using a first hypervisor, a computer system.

In Example 30, the machine readable storage device includes instructions, which when performed by machine, cause the machine to perform operations comprising collecting, using the first hypervisor, data representative of the state of the computer system at the time the computer system was halted.

In Example 31, the instructions for collecting the data representative of the state of the computer system at the time the computer system was halted of at least one of Examples 1-30 include instructions, which when performed by the machine, cause the machine to perform operations comprising collecting the contents of a volatile memory of the computer system and a non-volatile memory of the computer system at the time the computer system was halted.

In Example 32, instructions for collecting the data representative of the state of the computer system at the time the computer system was halted of at least one of Examples 1-31 include instructions, which when performed by the machine, cause the machine to perform operations comprising collecting data representative of the state of a central processing unit of the computer system and the contents of a drive of the computer system, at the time the computer system was halted.

In Example 33, the instructions for halting the computer system of at least one of Examples 1-32 include instructions, which when performed by the machine, cause the machine to perform operations comprising halting the computer system using a type I hypervisor.

In Example 34, the machine readable storage device of at least one of Examples 1-33 includes instructions, which when performed by the machine, cause the machine to perform operations comprising hot-loading the first hypervisor between a running instance of the operating system and hardware of the computer system.

In Example 35, the machine readable storage device of at least one of Examples 1-34 includes instructions, which when performed by the machine, cause the machine to perform operations comprising transmitting the data representative of the state of the computer system to an external memory.

In Example 36, the machine readable storage device of at least one of Examples 1-35 includes instructions, which when performed by the machine, cause the machine to perform operations comprising compressing the data representative of the state of the computer system.

In Example 37, the instructions for transmitting the data of at least one of Examples 1-36 include instructions, which when performed by the machine, cause the machine to perform operations comprising transmitting, using a universal serial bus (USB), the data representative of the state of the computer system.

In Example 38, the instructions for transmitting the data of at least one of Examples 1-37 include instructions, which when performed by the machine, cause the machine to perform operations comprising transmitting data representative of the entire state of all volatile and non-volatile memory of the computer system at the time the computer system was halted.

In Example 39, the instructions for transmitting the data of at least one of Examples 1-38 include instructions, which when performed by the machine, cause the machine to perform operations comprising transmitting data representative of the entire state of the operating system of the computer system at the time the computer system was halted.

In Example 40, the machine readable storage device of at least one of Examples 1-39 includes instructions, which when performed by the machine, cause the machine to perform operations comprising receiving the data representative of the state of the computer system at a second hypervisor.

In Example 41, the machine readable storage device of at least one of Examples 1-40 includes instructions, which when performed by the machine, cause the machine to perform operations comprising analyzing the state of the computer system using, at least partially, the second hypervisor.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the disclosed subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The functions or algorithms described herein are implemented in hardware, software, or a combination of software and hardware in some embodiments. The software can comprise computer executable instructions stored on computer readable media such as memory or other type of storage devices. Further, described functions can correspond to modules, which can be software, hardware, firmware, or any combination thereof. Multiple functions are performed in one or more modules as desired, and the embodiments described are merely embodiments. The software is executed on a digital signal processor, ASIC, microprocessor, or other type of processor operating on a system, such as a personal computer, server, a router, or other device capable of processing data including network interconnection devices.

Some embodiments implement the functions in two or more specific interconnected hardware modules or devices with related control and data signals communicated between and through the modules, or as portions of an application-specific integrated circuit. Thus, process flows can be applicable to software, firmware, and hardware implementations.

Systems and methods of the present disclosure can be implemented on a mobile device as a mobile application, web-based application, on a desktop computer as a computer application, or a combination thereof. A mobile application can operate on a Smartphone, tablet computer, portable digital assistant (PDA), ruggedized mobile computer, or other mobile device. The mobile device can be connected to the Internet or network via Wi-Fi, Wide Area Network (WAN), cellular connection, WiMax, Serial Front Panel Data Port (Serial FPDP), Rapid I/O (Input/Output) Transport, or any other type of wired or wireless method of networking connection. In some embodiments, a web-based application can be delivered as a software-as-a-service (SaaS) package (e.g. cloud-based embodiments) accessible via a device app, a web browser application, or other suitable application, depending on the particular embodiment.

It will be readily understood to those skilled in the art that various other changes in the details, material, and arrangements of the parts and method stages which have been described and illustrated in order to explain the nature of the inventive subject matter may be made without departing from the principles and scope of the inventive subject matter as expressed in the subjoined claims.

What is claimed is:

1. A system comprising:
a first hypervisor configured to:
halt a computer system including a central processing unit, a drive, a volatile memory, and a non-volatile memory; and
collect data representative of a state of the computer system at the time the computer system was halted, the data representative of the state of the computer system including the contents of the volatile and non-volatile memory at the time the computer system was halted, wherein at least a portion of the collected data is representative of the state of the central processing unit and the contents of the drive, at the time the computer system was halted.

2. The system of claim 1, wherein the first hypervisor is configured to hot-load itself between a running instance of an operating system and hardware of the computer system.

3. The system of claim 1, wherein the first hypervisor is a type I hypervisor.

4. The system of claim 1, wherein the first hypervisor is configured to transmit the data representative of the state of the computer system to an external memory.

5. The system of claim 4, wherein:
the first hypervisor is configured to transmit, using a universal serial bus (USB), the data representative of the state of the computer system;
the data representative of the state of the computer system includes data representative of the entire state of all volatile and non-volatile memory of the computer system at the time the computer system was halted;
the data representative of the state of the computer system includes data representative of the entire state of the operating system of the computer system at the time the computer system was halted; and
the first hypervisor is configured to compress the data representative of the state of the computer system before transmitting the data representative of the state of the computer system.

6. The system of claim 1, comprising an analysis tool comprising:
a second hypervisor configured to receive the data representative of the state of the computer system at the time the computer system was halted, and the second hypervisor configured to help analyze the data representative of the state of the computer system.

7. The system of claim 6, wherein the second hypervisor is a type II hypervisor.

8. A method comprising:
halting, using a first hypervisor, a computer system including a volatile memory, a non-volatile memory, a central processing unit, and a drive; and
collecting, using the first hypervisor, data representative of a state of the computer system at the time the computer system was halted, the data representative of the state of the computer system including the contents of the volatile and non-volatile memory at the time the computer system was halted, and wherein at least a portion of the collected data is representative of the state of the central processing unit and the contents of the drive, at the time the computer system was halted.

9. The method of claim 8, wherein halting, using the first hypervisor, includes halting the computer system using a type I hypervisor.

10. The method of claims 8, comprising hot-loading, using the first hypervisor, the first hypervisor between a running instance of an operating system and hardware of the computer system.

11. The method of claim 8, comprising transmitting the data representative of the state of the computer system to an external memory.

12. The method of claim 11, wherein:
transmitting the data representative of the state of the computer system includes transmitting, using a universal serial bus (USB), the data representative of the state of the computer system
transmitting the data representative of the state of the computer system includes transmitting data representative of the entire state of all volatile and non-volatile memory of the computer system at the time the computer system was halted;
transmitting the data representative of the state of the computer system includes transmitting data representative of the entire state of the operating system of the computer system at the time the computer system was halted; and the method comprises compressing the data representative of the state of the computer system.

13. The method of claim 11, comprising:
receiving the data representative of the state of the computer system at a second hypervisor; and
analyzing the state of the computer system using, at least partially, the second hypervisor.

14. The method of claim 13, wherein receiving the data representative of the state of the computer system includes receiving the data representative of the state of the computer system at a type II hypervisor.

15. A machine readable storage device that stores instructions, the instructions, which when performed by a machine, cause the machine to perform operations comprising:
halting, using a first hypervisor, a computer system including a volatile memory, a non-volatile memory, a central processing unit, and a drive; and
collecting, using the first hypervisor, data representative of a state of the computer system at the time the computer system was halted, the data representative of the state of the computer system including the contents of the volatile and non-volatile memory at the time the computer system was halted, and wherein at least a portion of the collected data is representative of the state of the central processing unit and the contents of the drive, at the time the computer system was halted.

16. The machine readable storage device of claim 15, wherein the instructions for halting the computer system include instructions which when performed by the machine, cause the machine to perform operations comprising halting the computer system using a type I hypervisor.

17. The machine readable storage device of claim 15, wherein the instructions include instructions which when performed by the machine, cause the machine to perform operations comprising:
hot-loading the first hypervisor between a running instance of an operating system and hardware of the computer system.

18. The machine readable storage device of claim 15, wherein the instructions include instructions which when performed by the machine, cause the machine to perform operations comprising:
transmitting the data representative of the state of the computer system to an external memory.

19. The machine readable storage device of claim 18, wherein the instructions include instructions which when performed by the machine, cause the machine to perform operations comprising compressing the data representative of the state of the computer system; and
wherein the instructions for transmitting the data include instructions which when performed by the machine, cause the machine to perform operations comprising:
transmitting, using a universal serial bus (USB), the data representative of the state of the computer system;
transmitting data representative of the entire state of all volatile and non-volatile memory of the computer system at the time the computer system was halted; and
transmitting data representative of the entire state of the operating system of the computer system at the time the computer system was halted.

20. The machine readable storage device of claim 15, wherein the instructions include instructions which when performed by the machine, cause the machine to perform operations comprising:
receiving the data representative of the state of the computer system at a second hypervisor; and
analyzing the state of the computer system using, at least partially, the second hypervisor.
